(19) United States
(12) Patent Application Publication
(10) Pub. No.: US 2014/0103029 A1
(43) Pub. Date: Apr. 17, 2014

(54) DEVICE FOR INDUCTIVELY REMOVING THE INSULATION FROM WIRES AND/OR CONDUCTIVE STRUCTURES

(71) Applicants: Bernd Maryniak, Seehof (DE); Timo Saathoff, Ihlow (DE); Mirko Fleischer, Detern (DE); Thorsten Claassen, Wittmund (DE); Carsten Wagenaar, Wirdum (DE)

(72) Inventors: Bernd Maryniak, Seehof (DE); Timo Saathoff, Ihlow (DE); Mirko Fleischer, Detern (DE); Thorsten Claassen, Wittmund (DE); Carsten Wagenaar, Wirdum (DE)

(73) Assignee: WOBBEN PROPERTIES GMBH, Aurich (DE)

(21) Appl. No.: 13/985,228

(22) PCT Filed: Feb. 14, 2012
(86) PCT No.: PCT/EP2012/052453

§ 371 Date: Dec. 23, 2013

(30) Foreign Application Priority Data
Feb. 14, 2011 (DE) 10 2011 004 078.1

(51) Int. Cl. H02G 1/12

(52) U.S. Cl. CPC H02G 1/128
USPC 219/636; 81/9.4

(57) ABSTRACT

Thus there is provided a device for stripping insulation from wires and/or conductive structures having a lacquer or plastic coating. The device has a receiving portion for receiving the ends of the wires and/or conductive structures from which insulation is to be stripped, at least one induction coil in the region of the receiving portion for inductively generating heat to vaporize or thermally remove the coating on the wires within the receiving portion and at least one suction removal hose connected to the receiving portion for removing the vaporized or thermally removed coating of the wires and/or conductive structures in the region of the receiving portion.

### BACKGROUND

1. Technical Field

The present invention concerns a device for and a method of inductively stripping insulation from wires and/or conductive structures.

2. Description of the Related Art

When wiring a synchronous generator in a wind power installation and at other locations in a wind power installation, the electric components have to be connected together for example by electric cables. That is often effected by a bundle of conductors consisting of multiple electric wires in which each has an insulating lacquer layer there around. The insulating layer or the lacquer layer then has to be removed at the ends of the wires so that an electric or galvanic connection can be made to the respective electric components. Hitherto stripping the insulation at the ends of the wires or conductive structures is effected mechanically.

As general state of the art attention is directed to DE 1 064 580 B, DE 10 2008 043 876 A1 and DE 601 28 389 T2.

### BRIEF SUMMARY

Embodiments of the present invention are directed to a device for and a method of stripping insulation of wires and/or conductive structures, which permit rapid stripping of insulation with a uniform quality.

In one embodiment there is provided a device for stripping insulation from wires and/or conductive structures having a lacquer or plastic coating. The device has a receiving portion for receiving the ends of the wires and/or conductive structures from which insulation is to be stripped, at least one induction coil in the region of the receiving portion for inductively generating heat to vaporize or thermally remove the coating on the wires or conductive structures within the receiving portion and at least one suction removal hose connected to the receiving portion for sucking away the vaporized or thermally removed coatings of the wires and/or conductive structures in the region of the receiving portion.

The coatings on the wires and/or conductive structures can be vaporized or thermally removed with the device and sucked away by the suction removal hose, which is coupled to a suction device for providing the suction. That makes it possible to quickly and easily strip insulation from the wires in an automatic procedure.

In addition in an aspect of the invention there is provided a compressed air hose which feeds compressed air into the receiving portion for cooling the heated wire ends and for removing the residues of the coating in the region of the receiving portion. Surface tensions are produced by the compressed air at a corresponding pressure and the heated ends are cooled. In addition at the same time the residues of the coating in the region of the receiving portion can be simultaneously blown away and disposed of through a suction removal hose.

In a further aspect of the present invention a further portion is arranged around the outside wall of the receiving portion so that a hollow chamber is defined between the outside wall of the receiving portion and the further portion. In that case the compressed air is urged or blown through that hollow chamber and through holes in the outside wall of the receiving portion. The compressed air and any particles and gases present can then be sucked away by way of the suction removal hose.

The invention also concerns a method of stripping insulation from wires and/or conductive structures with coatings. The ends of the wires and/or conductive structures to be stripped are introduced into a receiving portion. Inductive generation of heat is implemented in the region of the receiving portion by means of at least one induction coil to vaporize or thermally remove the insulations or coatings on the wires and/or conductive structures. The vaporized coatings of the wires in the region of the receiving portion are sucked away by a suction removal hose.

The present invention also concerns a device for stripping insulation from wires and/or conductive structures with a lacquer or plastic coating. The device has a receiving portion for receiving the ends of the wires and/or conductive structures to be stripped of insulation. The device further has at least one induction coil in the region of the receiving portion for inductively generating heat to vaporize or thermally remove the coating of the wires and/or conductive structures within the receiving portion. The device further has a suction removal hose connected to the receiving portion for sucking away the vaporized or thermally removed coating of the wires and/or conductive structures in the region of the receiving portion. The device further has a compressed air hose for feeding compressed air into the receiving portion for cooling the heated ends of the wires and/or conductive structures and for removing residues of the coatings in the region of the receiving portion. The device further has an outside wall of the receiving portion and a portion arranged therearound, a hollow chamber being provided between the portion and the outside wall. The compressed air hose opens into the hollow chamber. Provided in the outside wall of the receiving portion are holes through which the compressed air can flow out of the compressed air hose. The device further has reduction units which can be introduced into the receiving portion to reduce the inside diameter of the receiving portion.

In one embodiment, there is provided a device for inductively stripping insulation from wires and/or conductive structures, wherein the ends of the wires, from which insulation is to be stripped, are introduced into the device and heat is generated inductively (that is to say the copper of the lines is inductively heated) so that the coatings on the wires are vaporized and the gases or vapors are removed, such as by suction. Then or parallel thereto compressed air can be used for cooling the stripped ends of the wires and for better releasing and removing residues on the surface. According to the invention the device for stripping insulation from wires and/or conductive structures can be used in the area of a wind power installation.

Further configurations of the invention are subject-matter of the appendant claims.

### BRIEF DESCRIPTION OF THE SEVERAL VIEWS OF THE DRAWINGS

Advantages and embodiments by way of example of the invention are described more fully hereinafter with reference to the drawing.

FIG. 1 shows a diagrammatic sectional view of a part of the device for stripping insulation from wires according to a first embodiment, and

FIG. 2 shows a diagrammatic perspective view of part of the device for stripping insulation from wires according to the first embodiment.

### DETAILED DESCRIPTION

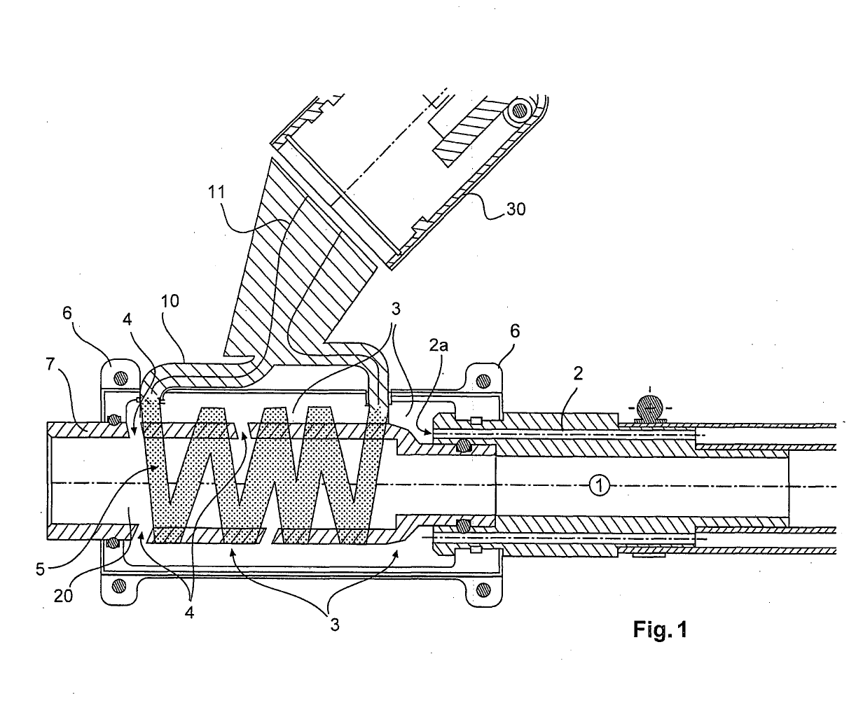

FIG. 1 shows a diagrammatic sectional view of a part of the device for stripping insulation from wires and/or conductive structures. The device has a suction removal hose 1, an induction coil 5, 10 and an introduction portion 20 for introducing the ends of the wires and/or conductive structures from which the insulation is to be stripped. A tube 7 is provided around the portion 20 and two half-shell portions 6 are provided around the inductor 10. A second hose (compressed air hose) 2 (for example arranged around the first hose 1) serves for the feed of compressed air (for example 6-10 bars). A hollow chamber 3 is provided between the half-shell portion 6 and the tube 7. A plurality of through bores or compressed air bores 4 are provided in the tube 7, wherein the compressed air can be guided or blown from the second hose (compressed air hose) 2 through the hollow chamber 3 and through the openings 4 into the receiving portion 20 for cooling the ends of the wires therein.

Connections 11 of the induction coil 5, 10 are guided in an inductor portion 30 and can be provided on a hand operating unit which can serve to receive the feed cable. The inductor coil is preferably water-cooled. The induction coil can be screwed to a hand portion. The induction coil can be of different sizes in dependence on the wire cross-section.

The length of the introduction portion 20 can be variable so that the length of the region of the wires, that is to be stripped of insulation, is also adjustable. In addition a reduction unit can be introduced into the introduction portion 20. The reduction unit can be for example in the form of a hollow cylinder, wherein provided in the hollow cylinder are openings or bores corresponding to openings or bores 4 in the tube 7. That reduction unit can be adapted to be replaceable. The thickness of the wall of the reduction unit is also adjustable or different reduction units of differing thicknesses can be provided so that conductor bundles of differing thicknesses can also be processed in the device for stripping insulation from wires.

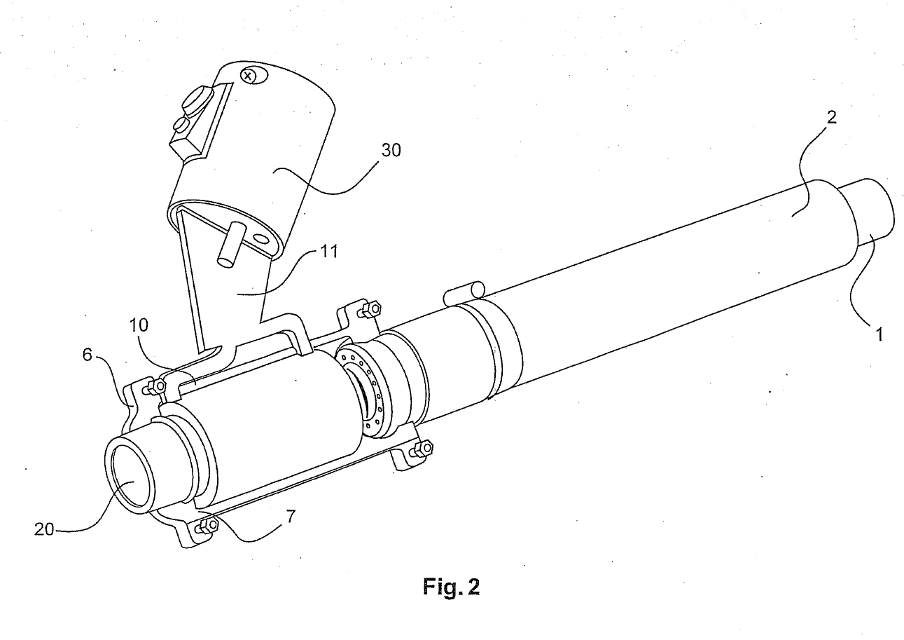

FIG. 2 shows a diagrammatic partial view in section of the device for stripping insulation from wires according to the first embodiment. The device has an (inside) tube 7, two half-shell portions 6, a (water-cooled) induction coil 10 and a receiving portion 20 for receiving the ends of the wires that are to be stripped of insulation. The device further has a first hose 1 for sucking away fumes, combustion residues and vapors which occur in the operation of inductively stripping insulation from the wires. The device further has a second hose 2 serving to feed compressed air into the receiving portion 20. The compressed air can be fed into a hollow chamber 3 between the half-shell portion 6 and the tube 7 by way of openings 2a at the end of the second hose (compressed air hose) 2. The compressed air can pass from the hollow chamber 3 by way of openings 4 in the tube 7 into the receiving portion 20.

The connections 11 of the induction coil 10 pass through the portion 30 to the appropriate voltage supply. Water cooling of the induction coil can be provided both in the portion 30 and also within the two half-shell portions.

As an alternative thereto cooling water can also be caused to flow through the induction coil from the inside.

A bundle of wires which are to be stripped of insulation is introduced into the receiving portion 20 within the tube 7. The length of the receiving portion 20 or the depth of penetration of the end of the wires, that is to be stripped of insulation, is adjustable. Inductive heat is generated within the receiving portion 20 by means of the induction coil 10 so that the insulations on the wires or the insulating lacquer can melt or burn away and vaporize within that portion, that is to say the lacquer or coatings on the wires is thermally removed. The vaporized or thermally removed insulating material can be sucked away by way of the hose 1. After the insulation has been stripped off by vaporization or thermal removal of the insulating material compressed air can be introduced into the hollow chamber 3 by means of the second hose 2 and the openings 2a, the compressed air then passing through the openings 4 in the tube in the receiving portion 20 and cooling the heated ends of the wires. The compressed air can then in turn be sucked away by way of the first hose 1 and can suck away particles of the insulating material.

The device according to the invention for stripping insulation from wires can provide a simple, quick and inexpensive possible way of stripping insulation from wires. The insulation stripping operation can be effected automatically and with uniform quality. The wires or conductive structures to be stripped of insulation can be used for example in wiring of a synchronous generator, for example for a wind power installation. Alternatively the device for stripping insulation from wires and/or conductive structures can also be used for stripping insulation from electric wires or electric conductive structures in the area of a wind power installation.

While in the state of the art the insulation stripping operations had to be effected mechanically, the insulation on the wires according to the invention is vaporized or detached by inductive heat (that is to say thermally removed) and the vaporized or thermally removed particles of the insulations can be sucked away. Compressed air can be used for cooling the heated ends.

The induction coil 10 produces a magnetic field which can heat the copper in the bundle to 800 to 900 degrees F. so that the coating is vaporized or thermally removed.

The time for the heating operation, the suction removal of fumes and vaporized particles, and also the cooling operation can be effected automatically or in partly automated fashion with the device for stripping insulation from wires.

Subjecting the ends of the wires that are to be stripped of insulation to compressed air is not only advantageous for cooling purposes but as a result the residues of the insulation or the lacquer residues are also blown away or blown off in the direction of the suction removal hose 1.

The heating process can last for example between 5 and 7 seconds, the blowing operation can last between 15 and 20 seconds. Sucking air away through the first suction removal hose 1 is preferably always activated so that no toxic vapors can escape.

In an aspect of the invention there can be provided a sealing cap for sealing off the opening of the receiving portion when the ends that are to be stripped of insulation are introduced.

The device for and the method of stripping insulation from wires may be used in particular for generator and choke connections in a wind power installation. The insulated copper wires which are combined together in a conductor bundle are to be inductively stripped of insulation in the device/method according to the invention. The device according to the invention is preferably provided on a displaceable rolling truck. The device preferably has a high frequency (HF) generator for generating the required HF AC voltage for powering the induction coil. The suction removal hose 1 is preferably flexible to improve handling of the device. Handles can optionally be provided in the region of the end of the device, at which the receiving unit is provided.

The device can have an input unit for inputting a program, a bar code, a number or the like. The device can be appropriately controlled on the basis of the bar code, number and so forth. That can involve for example the length of the heating phase, the length of the cooling phase, the period of time for which compressed air is supplied, and so forth.

The insulation stripping region of the wires that are to be stripped of insulation can be set for example in a region of 30 mm to 70 mm (for example with setting spacings of 5 mm). A sensor for detecting an introduced wire can be provided in the region of the receiving portion 20. Optionally the coil may be activated only after detection of an introduced wire so that it is possible to avoid activation of the coil when a wire is not introduced. The device can optionally also have a display unit for displaying whether the wires are or are not introduced.

The insulation stripping operation (activation of the induction coil) can be effected manually by actuation of a key or automatically when the wires to be stripped of insulation have been introduced into the receiving portion.

The wires used should have an insulating material or an insulating lacquer or layer which have a vaporization temperature substantially lower than the melting temperature of the wires used.

The device for stripping insulation from wires and/or conductive structures according to the first embodiment can also be used for inductively heating cable ends, on to which a cable shoe is to be squeezed. The inductively heated cable end and the cable shoe can then be soldered in the region of the inductively heated wire end of the cable shoe. The device according to the second embodiment can in that case substantially correspond to the device of the first embodiment so that the cable end to be heated is introduced with the cable shoe fixed thereon into the introduction portion 20, the induction coil is activated and thus heats the copper in the cable ends. To improve the fixing of the cable shoe to the wire ends a soldering operation can be effected, wherein the wire end is heated or warmed up in such a way that the heat is sufficient to melt the soldering tin so that the soldering tin can flow into the inside region of the cable shoe and thus an improved fixing action can be achieved.

In a third embodiment which can be based on the first or second embodiment the device has two introduction units each having a respective induction coil, wherein the first introduction portion serves to strip the insulation from the wires or conductive structures and the second introduction portion serves to heat the cable ends to solder a cable shoe to the cable end. As in the first or second embodiment compressed air can be used to cool the soldered wire or profile ends. In addition the fumes produced in the soldering operation (like the thermally removed coatings) can be sucked away through the above-described hose 1.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for stripping insulation from conductive structures, the device comprising:
a receiving portion for receiving the ends of the conductive structures from which the insulation is to be stripped;
at least one induction coil in a region of the receiving portion for inductively generating heat to at least one of vaporize and thermally remove the insulation on the conductive structures within the receiving portion; and
at least one suction removal hose having an opening in fluid communication with the receiving portion for removing vapors or thermally removed insulation of the conductive structures from the region of the receiving portion.

2. The device according to claim 1 further comprising a compressed air hose in fluid communication with the receiving portion for providing compressed air into the receiving portion for cooling the heated ends of the conductive structures and for removing residues of the insulation in the region of the receiving portion.

3. The device according to claim 2 further comprising an outside wall of the receiving portion and an outer portion arranged therearound, wherein a hollow chamber is located between the outer portion and the outside wall, wherein the compressed air hose opens into the hollow chamber, and wherein provided in the outside wall of the receiving portion are holes through which the compressed air can flow.

4. The device according to claim 1 wherein a length of the receiving portion is variable.

5. The device according to claim 1 further comprising insertable reduction units in the receiving portion configured to reduce an inside diameter of the receiving portion.

6. A method of stripping insulation from conductive structures, the method comprising:
introducing ends of the conductive structures from which insulation is to be stripped into a receiving portion;
inductively generating heat in a region of the receiving portion by at least one induction coil to at least one of vaporize and thermally remove the insulation on the conductive structures within the receiving portion; and
using suction to remove at least one of the vapors or thermally removed insulation on the conductive structures in the region of the receiving portion.

7. The method according to claim 6 wherein the conductive structures are wires.

8. The method according to claim 6 further comprising cooling the ends of the conductive structures.

9. The device according to claim 1 wherein the conductive structures are wires.

10. A device comprising:
a tube having a first inner end portion that is configured to receive at least one conductive structure coated by an insulation material;
at least one conductive coil surrounding a region of the tube that is proximate the first inner end portion, the at least one conductive coil being configured to generate heat for at least one of vaporizing and thermally removing a portion of the insulation material on the at least one conductive structure; and
a suction device coupled to a hose, the hose having an opening in fluid communication with the first inner end portion, the suction device and the hose being configured to remove at least one of the vapors and the portion of the removed insulation material from the first inner end portion.

11. The device according to claim 10 wherein the hose is located outwardly of the tube, tube having a plurality of holes that places the opening of the hose in fluid communication with the first inner end portion of the tube.

12. The device according to claim 10 wherein the at least one conductive structures is a plurality of wires.
